(19) United States
(12) Patent Application Publication
(10) Pub. No.: US 2012/0174222 A1
(43) Pub. Date: Jul. 5, 2012

(54) METHOD FOR THE SAFETY OF NETWORK TERMINAL DEVICES

(76) Inventors: Yunfeng Peng, Chengdu (CN); Keping Long, Chengdu (CN); Chang Liu, Chengdu (CN); Xu Tao, Chengdu (CN); Yue Zhuo, Chengdu (CN)

(21) Appl. No.: 13/188,557

(22) Filed: Jul. 22, 2011

(30) Foreign Application Priority Data
Dec. 30, 2010 (CN) 201010613155.4

(51) Int. Cl. G06F 21/00

(52) U.S. Cl. 726/23

(57) ABSTRACT

The present invention provides a method for the safety of network terminal devices that utilizes the basic operations in network terminal devices (NTDs) and a network security center (NSC), as well as the analyzing and processing ability provided by the NSC to solve network security issues based on hierarchical network security structure of client request-server response. In the NSC, the solution is broken into a plurality of basic operations with their respective corresponding parameters. Each basic operation is encoded according to an operation code table (OCT) and encapsulated in a network security suspicion information packet (NSSIP). The NSC sends the NSSIP to the NTD. The NTD receives and splits the network security solution packet (NSSP) to get the plurality of operation codes and their respective corresponding parameters. The NTD retrieves a plurality of call interfaces from the OCT according to the plurality of operation codes. The plurality of call interfaces and their respective corresponding parameters is combined together to form a completely local solution to replace traditional patch and anti-virus module. Using this invention, the requirements on hardware are released so to fit well for various small-sized NTDs.

This application claims priority under the Paris Convention to Chinese Patent Application No. 201010613155.4, Filed Dec. 30, 2010, the entirety of which is hereby incorporated by reference for all purposes as if fully set forth herein.

### FIELD OF THE INVENTION

The present invention relates to the field of network technology, more particularly to the safety of network terminal devices.

### BACKGROUND OF THE INVENTION

With the development of computer and network technologies, people are more dependent on the network applications. However, with the expansion of network applications, the situation of network security will be more severe. How to ensure the safety of equipments in network has been a crucial issue.

Most traditional solutions to network security use the method of detecting virus attacks and network intrusions to ensure the safety of equipment in a network. Using such traditional solutions requires creating various patterns and detecting rules at network terminal device. Therefore, a network security provider must update a pattern database, release a wide variety of patches and add numerous components frequently to deal with ever increasing virus attacks and network intrusions. These approaches not only induce huge network traffic, but more importantly, also require more hardware resources and hardware support at the network terminal device. The continuous accumulation of patterns, patches and functional components will overwhelm many network terminal devices, even those with strong computing capability and large quantity of storage.

Nowadays, as technologies are improving, many small-sized intelligent network terminal devices, such as netbooks, smartphones, and other intelligent household electrical appliances are connected to a network to be beneficial for human studying, working and living. These devices have also become the targets of attack, which will bring unprecedented pressure to the network security, due to insufficient resources to accommodate large-scale security software and to store the huge patterns and various components.

The existing network security systems for small-sized intelligent terminal are essentially a simplified version of formal security software, and have not broken away from the traditional network security mode. When they are activated, such small-sized intelligent terminal devices will run slowly, and many system resources of small-sized intelligent terminal devices will be preempted. Therefore, traditional network security systems are not suitable for these small-sized intelligent terminal devices.

### SUMMARY OF THE INVENTION

Accordingly, the present invention is directed to a method for the safety of network terminal devices that obviates one or more of the problems due to limitations and disadvantages of the related art. The present invention aims to overcome the deficiencies of existing network security technologies and especially to reduce hardware and system requirements to provide a network security solution for small-sized intelligent devices.

To achieve these objectives, the present invention provides a method for the safety of network terminal devices, which comprises the following steps:

(1). an operation coding table (OCT) is created by encoding the basic operation of operating system of the network terminal devices (NTDs), and each basic operation corresponds to one unique operation code in the OCT; the OCT is saved in the network security center (NSC) and the NTDs respectively; in the NTDs, each basic operation of the OCT also corresponds to one call interface respectively, and each call interface can call the corresponding basic operation and provides parameters to the basic operation;

(2). the NTD receives data from the internet, and detects the data using intrusion detection module, meanwhile, the NTD detects its system performance using anomaly detection module; the NTD will send a network security suspicion information packet (NSSIP) to the NSC on finding any suspicious network data or system anomaly; the NSSIP is filled by suspicious network data or anomalies of the NTD;

(3). the NSC receives and analyzes the NSSIP sent by the NTD, and then provides a solution; the NSC breaks the solution into a plurality of basic operations with their respective corresponding parameters, and obtains a plurality of operation codes by searching the OCT with the plurality of basic operations; then the NSC encapsulates the plurality of operation codes and their respective corresponding parameters into a network security solution packet (NSSP), and then sends it to the NTD;

(4). the NTD receives and splits the NSSP to get the plurality of operation codes and their respective corresponding parameters; the NTD retrieves a plurality of call interfaces from OCT according to the plurality of operation codes. The plurality of call interfaces and their respective corresponding parameters are combined together to form a complete local solution.

The realization of the objectives proposed by the present invention is as follows:

In the existing network security solutions, the patterns are simply added and updated at the NTDs, and the NTDs repeatedly execute regular or irregular pattern matching detection, largely ignore the role of its own system and network communication in network security. Taking full use of the basic function modules in network equipment's own system and network communication, this invention proposes a method for the NTDs, especially for small-sized NTDs to accommodate the urgent network security requirements and reduce the resources occupied.

The present invention fully utilizes the basic operations in the NDTs and the NSC, as well as the analyzing and processing ability provided by the NSC to solve network security issues based on hierarchical network security structure of client request-server response. In the NSC, the solution is broken into a plurality of basic operations with their respective corresponding parameters; each basic operation is encoded according to the OCT and encapsulated in the NSSP. And then the NSC sends the NSSP to the NTD. The NTD receives and splits the NSSP to get the plurality of operation codes and their respective corresponding parameters; the NTD retrieves a plurality of call interfaces from the OCT according to the plurality of operation codes. The plurality of call interfaces and their respective corresponding parameters are combined together to form a complete local solution to replace traditional patch and anti-virus module. Using this invention, the requirements on hardware are released so to fit well for various small-sized NTDs.

The advantages of the present invention are as follows:

1. The present invention makes full use of basic operations residing in the NTDs to accomplish traditional operations of updated module, thus releases the rigid requirement for hardware, and reduces the process burden at the NTDs. The scope of traditional network security strategy is extended.

2. The present invention solves the incompatibility of conventional security solutions from different network security companies by encoding the basic operations of various operating systems into an uniform OCT, thus, the NSCs from different network security companies can use the uniform client cross-platform, the requirements of the NDTs are released.

3. Only a plurality of operation codes with their respective corresponding parameters are delivered in the present invention, therefor the network traffic is reduced.

Further embodiments, features, and advantages of the present invention, as well as the structure and operation of the various embodiments of the present invention, are described in detail below with reference to the accompanying drawings.

It is to be understood that both the foregoing general description and the following detailed description are exemplary and explanatory only, and are not restrictive of the invention as claimed.

### BRIEF DESCRIPTION OF THE DRAWINGS

The above and other objectives, features and advantages of the present invention will be more apparent from the following detailed description taken in conjunction with the accompanying drawings, in which:

FIG. 1 is a schematic diagram of the NSSP between the NSC and the NTD according to one embodiment of the present invention;

FIG. 2 is a schematic diagram of the NSSIP between the NSC and the NTD according to one embodiment of the present invention;

FIG. 3 is a schematic diagram of the data exchanging and processing between the NSC and the NTD according to one embodiment of the present invention;

FIG. 4 is a schematic diagram of the data transmitting and processing between the NTD and the NSC according to one embodiment of the present invention;

FIG. 5 is a schematic diagram of the NSC according to one embodiment of the present invention;

FIG. 6 is a schematic diagram of the receiving and detecting module in network terminal device according to one embodiment of the present invention;

FIG. 7 is a schematic diagram of the network security client according to one embodiment of the present invention;

FIG. 8 is an operating flowchart of the network security client according to one embodiment of the present invention.

### DETAILED DESCRIPTION OF THE ILLUSTRATED EMBODIMENTS

Hereinafter, embodiments of the present invention will be described with reference to the accompanying drawings. It should be noted that the similar modules are designated by similar reference numerals although they are illustrated in different drawings. Also, in the following description, a detailed description of known functions and configurations incorporated herein will be omitted when it may obscure the subject matter of the present invention.

With the development of computer and network technologies, various network terminal devices—from giant servers to cell phones and netbooks, even micro embedded terminal systems—are connected to a network such as an intranet or Internet. These devices have been facilitating and enriching people's lives, but they also make the situation of network security more severe. Facing various network security challenges, traditional antivirus software continually issues updating modules or dedicated antivirus modules, and keeps up-to-date with network security issues to a certain extent. But with the updating and installing of patterns, patches or new modules, more and more data volume is needed for maintaining and storing at the network terminal devices. Traditional network security methods have seriously limited the running speed of the network terminal devices, and especially is not suitable for small size network terminals.

Operations that patch and dedicated antivirus modules that perform network security may be viewed as combinations of basic operations including a series of basic file operations, e.g., create new files, delete files, modify files, view files, backup files, restore files, etc., and system function calls, e.g., terminate processes, disable ports, etc. The basic operations have been embedded into the network terminal devices. Therefore, there is no need to install extra patterns, patches or new modules to realize the similar functions. Instead, it is possible to inform the operation system of the network terminal devices what operations need to be done and what parameters are needed.

1. Establishing a Uniform Operation Code Table (OCT) Between the Network Security Center (NSC) and the Network Terminal Devices (NTDs).

In order to simplify the information exchange between the NSC and the NTDs, the basic operations of operating system in the NTDs are encoded to form a uniform OCT, so that the same operation of different operating systems has the same call interface and the same operation code. First, a unique call interface is specified for each basic operation of the NTDs, the operating system is able to call the corresponding operation and pass the appropriate parameters to the operation by using the call interface. Then, a unique operation code is designated to each basic operation, and the operating system is able to find the corresponding basic operation's call interface through the operation code.

Table 1 is an exemplary Operation Coding Table according to one embodiment of the present invention.

TABLE 1

| Operation Name | Call Interface | Operation Code |
|---|---|---|
| Create New File | CreateNewFileInterface | Oper00000001 |
| Read File | ReadFileInterface | Oper00000002 |
| Delete File | DeleteFileInterface | Oper00000003 |
| Modify File | ModifyFileInterface | Oper00000004 |
| . . . | . . . | . . . |

As shown in table 1, the call interface “CreateNewFileInterface” is specified for basic operation “create new file” of operating system in the NTD, and the operation code “Oper00000001” is designated to the basic operation. The call interface “CreateNewFileInterface” can call the basic operation “creat new file” of operating system in the NTD, and pass corresponding parameters to it.

It should be emphasized that: (1) the call interface and operation code for the same basic operation of different operating systems is identical to ensure compatibility; (2) both the NSC and the NTDs support the same OCT to ensure that the NTDs can correctly decode the solution of the NSC; (3) different NTDs will support the same OCT to ensure the generality of the network security solutions.

2. Establishing Uniform Communication Packet Format Between the NSC and the NTDs.

A uniform communication packet format for the network security solution packet (NSSP) is created to allow the NTD to quickly and accurately perform the basic operations split from the network security suspicion information packet (NSSIP). Thus, the solution sent by the NSC is accomplished by the NTD.

The requirements to the communication packet format are as follows: (1) the NSSIP should include authentication information to help the NTD confirm the safety of the message; (2) the NSSIP should be suitable for quick splitting to ensure that the NTD can quickly get the information of relevant operations after receiving the NSSIP; (3) the NSSIP should ensure the mapping between the operation code and its corresponding parameters.

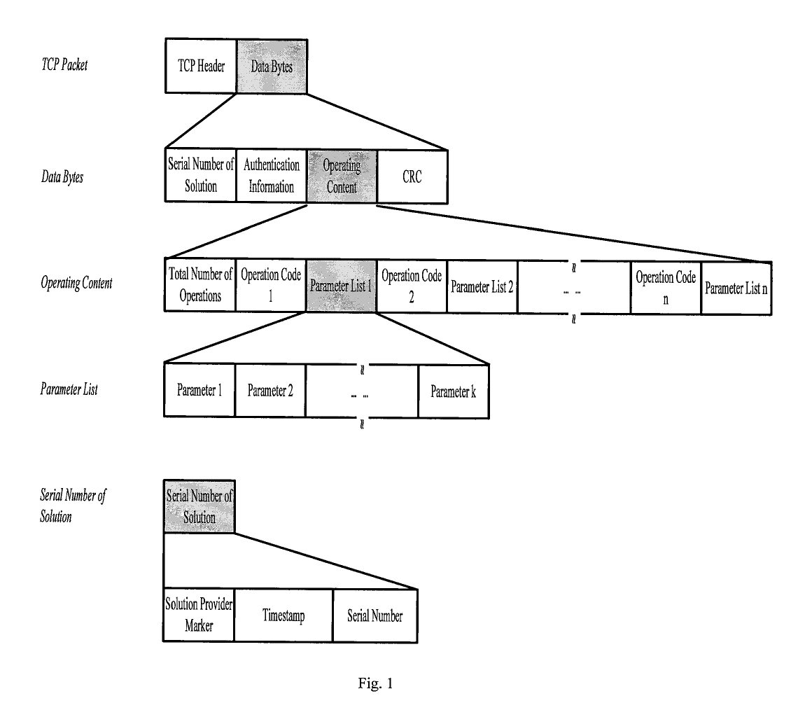

FIG. 1 is a schematic diagram of the NSSP between the NSC and the NTD according to one embodiment of the present invention.

In one embodiment, as shown in FIG. 1, the NSSP is a TCP packet, which comprises header and data bytes. The data bytes of the packet may have four parts, e.g., serial number of solution, authentication information, operating content, and cyclic redundancy check (CRC). Detailed description of each part is elaborated as follows:

(1). Serial number of solution: The serial number of solution is used to identify a solution. As shown in FIG. 1, serial number of solution comprises solution provider marker, timestamp, and serial number. The solution provider marker is used to distinguish different network security providers; timestamp is used to identify the release time of the solution; serial number is used to distinguish the solution from different security issues provided simultaneously by the same solution provider.

(2). Authentication information: The NTD checks the NSSP and evaluates its safety according to the authentication information.

(3). Operating content: Operating content is the core part of the NSSIP, and includes operation codes and parameters. The benefit of such arrangement of operating content is that the parameters required by each operation follow the corresponding operation code to ensure the correct mapping, and also to ensure every basic operation is identified. Thus, the sequence of basic operations that NTDs need to perform is exactly the same sequence order that the operation codes appear in the operating content.

(4). CRC: CRC is used to ensure the integrity of the NSSP.

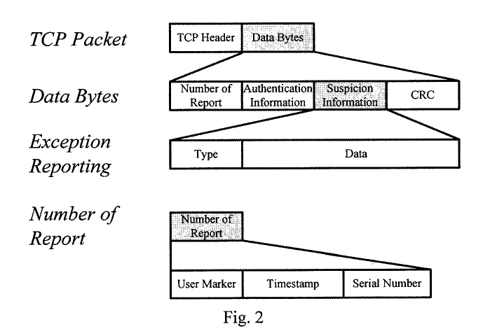

FIG. 2 is a schematic diagram of the NSSIP between the NSC and the NTD according to one embodiment of the present invention.

In one embodiment, as shown in FIG. 2, the NSSIP is a TCP packet, which also may include the header and data bytes. The data bytes may have four parts, e.g., number of report, authentication information, suspicion reporting, and CRC. Detailed functions of each part is elaborated as follows:

(1). Number of report: The number of report includes a user marker, timestamp, and serial number. The user marker is used to identify user's information and provides necessary information for the NSC to generate a solution in the future. It can be the user's IP address or the other unique identity assigned to user by the NSC. Timestamp records the time information when the NSDs find any suspicious data. On one hand it is used to distinguish different suspicion reporting, on the other hand it can provide statistic and queuing information for the NSC to handle suspicions sent by the NTDs. Serial number may be used to distinguish different suspicion reporting sent by NTD at the same time.

(2). Authentication information: Authentication information may contain the user's authentication information. The NSC may use the authentication information to check the legitimacy of the NTDs through related verifying technologies with it.

(3). Suspicion information: Suspicion information is a core part of packet and may include type and data. Type is used to inform the NSC whether the content of the suspicion reporting is suspicious network data or anomalies of the NTD. The data portion is used to provide suspicious network data or anomalies of the NTD according to the type.

(4). CRC: CRC is used to ensure the integrity of the NSSIP.

3. Exchanging and Processing the Data Between the Nsc and the NTDs.

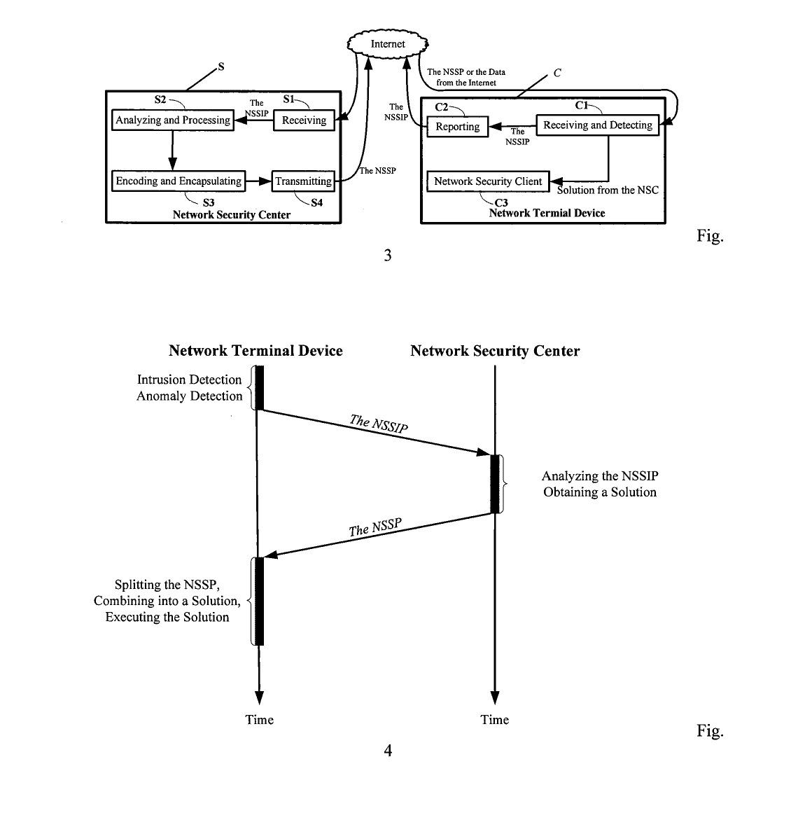

In one embodiment, as shown in FIG. 3. The network security center (the NSC) S includes receiving module S1, analyzing and processing module S2, encoding and encapsulating module S3, transmitting module S4. The NTD C includes receiving and detecting module C1, reporting module C2, network security client module C3. The functions of each module are elaborated as follows:

The network security center S:

The request receiving module S1: This module receives the NSSIP submitted by the NTD;

The analyzing and processing module S2: This module analyzes the NSSIP submitted by the NTD and provides a solution.

The encoding and encapsulating module S3: this module breaks the solution into a plurality of basic operations with their respective corresponding parameters and obtains a plurality of operation codes by searching the OCT with the plurality of basic operations. Then, this module encapsulates the plurality of operation codes and their respective corresponding parameters into a network security solution packet (NSSP).

Transmitting module S4: this module sends the NSSP to the NTD that submitted the NSSIP.

Network terminal device C:

The receiving and detecting module C1: this module receives data from the Internet, and detects the data using intrusion detection module. Meanwhile, the NTD detects its system performance using an anomaly detection module. Once any suspicious network data or system anomaly is found, and this module will fill it into the NSSIP, and submits the NSSIP to the reporting module C2.

The reporting module C2: this module sends the NSSIP to the NSC to process.

The network security client C3: this module handles the NSSP coming from the NSC, splits the NSSP to get the plurality of operation codes and their respective corresponding parameters, retrieves a plurality of call interfaces from the OCT according to the plurality of operation codes, combines the plurality of call interfaces and their respective corresponding parameters to form a completely local solution, and then executes the solution.

The steps of exchanging and processing the data between the NSC and the NTDs are as follows:

In one embodiment, as shown in FIG. 3, when receiving and detecting module C1 in the NTD C finds any suspicious network data or system anomaly, it will fill them into the NSSIP, and submits the NSSIP to reporting module C2, and sends them to the NSC S through reporting module C2.

After the NSC S receives the NSSIP, the analysis and processing module S2 analyses the suspicious network data or system anomaly and then provides a solution. Encoding and encapsulating module S3 breaks the solution into a plurality of basic operations with their respective corresponding parameters, then encodes the plurality of basic operations according to the mapping of basic operation and operation code in the OCT, encapsulates the plurality of operation codes and their respective corresponding parameters into a network security solution packet (NSSP). Finally transmitting module S4 sends the NSSP to the NTD C that submitted the NSSIP.

When receiving the NSSP from the NSC, the receiving and detecting module C1 in the NTD C will check the NSSP. If the NSSP is correct, the receiving and detecting module C1 will send it to the network security client C3. The network security client C3 splits the NSSP to get the plurality of operation codes and their respective corresponding parameters, and then decodes the plurality of operation codes according to the OCT, retrieves a plurality of call interfaces from the OCT. The network security client C3 passes respective corresponding parameters to each one of the plurality of call interfaces, and combines them in turn to form a completely local solution, then executes the local solution.

The steps of exchanging and processing the data between the NSC and the NTDs detailed above are shown in FIG. 4.

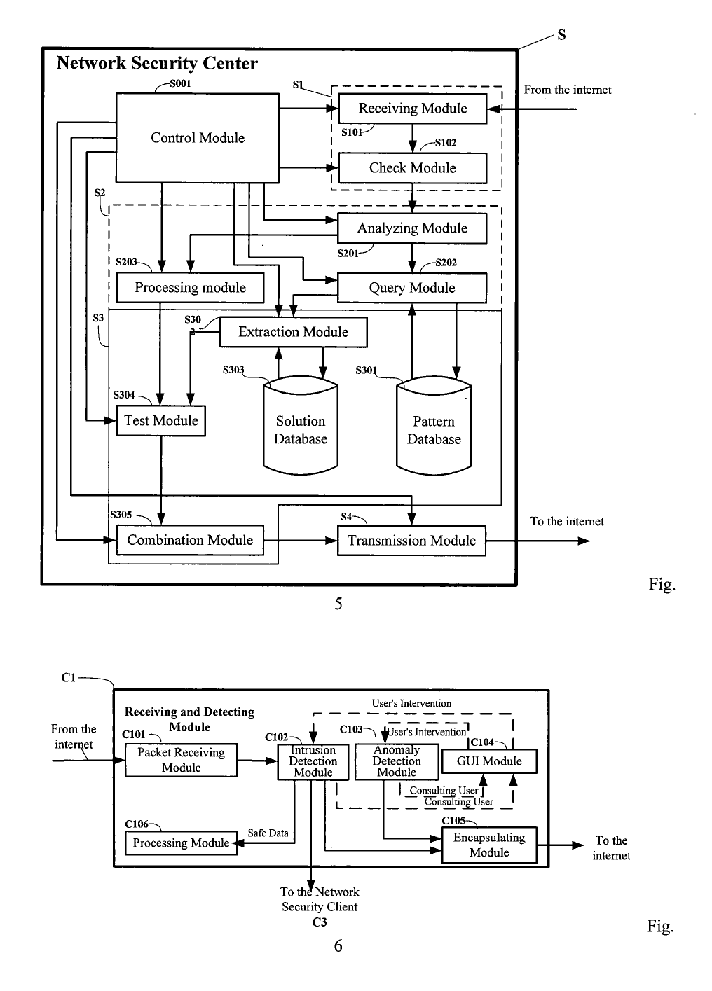

FIG. 5 is a diagram of the NSC according to one embodiment of the present invention.

The functions of modules of the NSC are as follows:

The request receiving module S1 includes receiving module S101 and check module S102.

The receiving module S101 receives the NSSIP sent by the NTDs from the Internet.

The check module S102 checks the legitimacy of the NSSIP.

The analyzing and processing module S2 comprises analyzing Module S201, query module S202 and processing module S203.

The analyzing module S201 analyzes the NSSIP sent by the NTD and extracts the pattern information from the NSSIP.

The query module S202 queries the pattern database S301 whether there is a matching according to the pattern information provided by analyzing module S201, then retrieves the pattern code from the pattern database and sends to extraction module S302, when there is a matching.

The processing module S203 analyzes and processes the pattern information that cannot be identified by query module S202 and then generates a solution through artificial means or other equipment.

The encoding and encapsulating module S3 includes pattern database S301, extraction module S302, solution database S303, test module S304 and combination module S305.

The pattern database S301 stores in which the patterns of the known network security issues.

The extraction module S302 extracts the corresponding solution from the solution database S303 according to the pattern code and sends the solution to the test module S304.

The solution database 5303 stores in which the solutions of the known security issues.

The test module S304 breaks the solution into a plurality of basic operations with their respective corresponding parameters and encodes the plurality of basic operations according to the OCT, then tests the plurality of basic operations to ensure that the solution can be executed.

The combination module S305 encapsulates the plurality of operation codes and their respective corresponding parameters into the NSSP.

The transmitting module S4 sends the NSSP to the NTD C that submitted the NSSIP.

In one embodiment, as shown in FIG. 5, the control module S001 calls each module to accomplish corresponding functions. The NSSIP submitted by the NTD C are sent to the NSC through the Internet and is received by receiving module S101. Check module S102 checks the legitimacy and integrity of the NSSIP, and the authenticated NSSIP will be sent to analyzing module S201. Analyzing module S201 obtains the pattern information by analying the NSSIP. Query module S202 queries the pattern database S301 according to the pattern information provided by analyzing module S201, and informs extraction module S302 to extract corresponding solution from solution database S303 and send it to test module S304 when there is a matching. If there is not a matching, analyzing module S201 will send the pattern information to processing module S203. Processing module S203 analyzes and processes the pattern information, then generates a solution through artificial means or other equipment and send it to test module S304. Test module S304 breaks the solution into a plurality of basic operations with their respective corresponding parameters and encodes the plurality of basic operations according to the OCT, then tests the plurality of basic operations. If the solution can't meet the requirement of execution, it should be regenerated; otherwise it will be passed to combination module S305. According to the packet format, combination module S305 encapsulates the plurality of operation codes and their respective corresponding parameters into a network security solution packet (NSSP). Finally, the NSSP will be sent by transmission module S4 to the NTD C that submitted the NSSIP.

FIG. 6 is a schematic diagram of the receiving and detecting module in network terminal device according to one embodiment of the present invention.

In one embodiment, as shown in FIG. 6, the receiving and detecting module C1 in the NTD includes data packet receiving module C101, intrusion detection module C102, anomaly detection module C103, GUI module C104, and encapsulating module C105, with each module's functions as follows:

The data packet receiving module C101 receives the data packets from the internet and sends to intrusion detection module C102.

The intrusion detection module C102 detects the data packets. If the data packets are hazardous data packets, the intrusion detection module C102 will discard them. If the data packets are the safe data packets, the intrusion detection module C102 will send them to the processing module C106, and the processing module C106 continues to process it normally. If the data packets are the NSSPs, the intrusion detection module C102 will send them to the network security client C3. If the data packets are suspicious, the intrusion detection module C102 will send them to the GUI module C104 for user's intervention; the suspicious data packets will be sent to encapsulating module C105; the hazardous data packets will be discarded; the safe data packets will be sent to the processing module C106, the processing module C106 continues to process it normally.

The anomaly detection module C103 detects the system performance of the NTD to find out and processes the threat of security issues like latent viruses and intrusions, etc. Once any system anomaly is found, this module will send the system anomaly to the encapsulating module C105. If the system performance is uncertain, the anomaly detection module C103 will send it to the GUI module C104 for user's intervention. Once system anomaly is confirmed by user, this module will send the system anomaly to the encapsulating module C105.

The GUI (Graphical User Interface) module C104 is the interface between user, the intrusion detection module C102, and the anomaly detection module C103, and improves the detecting accuracy and reduces the false positive rate through user's participation.

The encapsulation module C105 encapsulates the suspicious data packets or anomalies sent from intrusion detection module C102 or anomaly detection module C103 into the NSSIP according to packet format, and then sends the NSSIP to the NSC S through the interne.

In one embodiment, as shown in FIG. 6, the data packets from the Internet reach the receiving and detecting module C1 of the NTDs. The data packet receiving module C101 receives the data packets and sends them to the intrusion detection module C102. The safe data packets having passed the detection will be further processed by the processing module C106. If the data packets are the NSSPs, the intrusion detection module C102 will send them to the network security client C3. If the data packets are the suspicious data packets, the suspicious data packets will be sent to encapsulating module C105. The encapsulating module C105 encapsulates the suspicious data packets into the NSSIP and sends the NSSIP to the NSC S. The NTD detects its system performance through anomaly detection module C103. Once any system anomaly is found, the encapsulating module C105 will encapsulates the anomaly into the NSSIP according to packet format, and then sends the NSSIP to the NSC S. The process of intrusion detection and anomaly detection can be controlled by user's intervention through the GUI C104 to minimize mistaking the NTD's normal behavior as intrusion or anomaly.

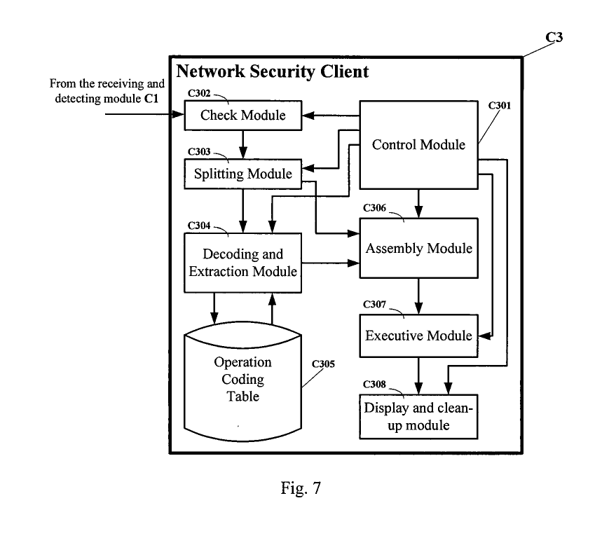

FIG. 7 is a schematic diagram of the network security client according to one embodiment of the present invention.

In one embodiment, as shown in FIG. 7, the network security client C3 includes control module C301, check module C302, splitting module C303, decoding and extraction module C304, operation coding table C305, assembly module C306, executive module C307 and display and clean-up module C308 with each module's functions as follows:

The control module C301 calls each module to accomplish corresponding functions.

The check module C302 uses the CRC fieldss as well as authentication information in the packets, to authenticate the integrity and legitimacy of the data.

The splitting module C303 separates the plurality of operation codes and their respective corresponding parameters from the operating content based on the operating content in the NSSP.

The decoding and extraction module C304 according to the order of operation codes and the mapping of basic operation and operation code in the OCT, forms a plurality of operation interfaces in proper order.

The operation coding table (OCT) C305 is a table that includes operation name, call interface and operation code, the three elements have mapping relations.

The assembly module C306 combines the plurality of operation interfaces extracted by decoding and extraction module C304 and their respective corresponding parameters separated by splitting module C303 into a completely local solution according to the order of the operation codes.

The executive module C307 executes the completely local solution that combined by assembly module C306.

The display and clean-up module C308: displays the processing results, and cleans up the garbage generated during network security process.

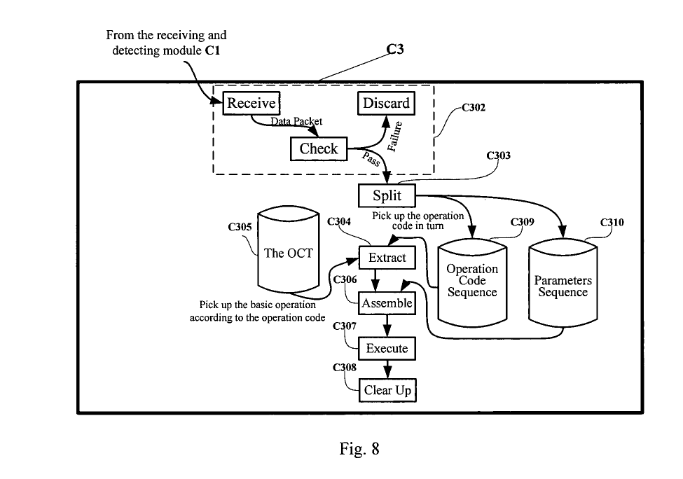

FIG. 8 is a operating flowchart of the network security client according to one embodiment of the present invention.

In one embodiment, as shown in FIG. 8, after passing intrusion detection, the NSSP sent from the NSC C to the NTDs is transmitted to check module C302 and will be authenticated. The packets which cannot pass the authentication will be discarded, and the packet passed are sent to splitting module C303 to be split, with the result that generating operation code sequence C309, i.e. a plurality of operation interfaces and parameters sequence C310, i.e. their respective corresponding parameters. Decoding and extraction module C304 picks the corresponding operation interfaces from operation coding table C305, according to the order of operation code sequence. Based on the corresponding operation interfaces, Assembly module C306 combines the plurality of operation interfaces extracted by decoding and extraction module C304 and their respective corresponding parameters separated by splitting module C303 into a completely local solution. Executive module C307 executes the solution combined by assembly module C306. And finally, display and clean-up module C308 feeds back the results to user and cleans up the garbage and releases resources.

While illustrative embodiments of the invention have been described above, it is, of course, understand that various modifications will be apparent to those of ordinary skill in the art. Such modifications are within the spirit and scope of the invention, which is limited and defined only by the appended claims.

What is claimed is:

1. A method for the safety of network terminal devices, comprising the following steps:
(1) creating an operation coding table (OCT) by encoding the basic operation of operating system of network terminal devices (NTDs), and each basic operation corresponding to one unique operation code in the OCT, wherein the OCT is saved in a network security center (NSC) and the NTDs respectively; wherein each basic operation of the OCT also corresponds to one call interface respectively, and each call interface is configured to call the corresponding basic operation and provide parameters to the basic operation;
(2) the NTD receiving data from the Internet, and detecting the data using intrusion detection module and detecting system performance using an anomaly detection module; sending a network security suspicion information packet (NSSIP) to the NSC on finding any suspicious network data or system anomaly; the NSSIP including suspicious network data or anomalies of the NTD;
(3) the NSC receiving and analyzing the NSSIP and providing a solution; breaking the solution into a plurality of basic operations with their respective corresponding parameters, and obtaining a plurality of operation codes by searching the OCT with the plurality of basic operations; encapsulating the plurality of operation codes and their respective corresponding parameters into a network security solution packet (NSSP), and sending the NSSP to the NTD;
(4) the NTD receiving and splitting the NSSP into the plurality of operation codes and their respective corresponding parameters; retrieving a plurality of call interfaces from OCT according to the plurality of operation codes and combining the plurality of call interfaces and their respective corresponding parameters to form a local solution.

2. The method for the safety of network terminal devices of claim 1, wherein the NSSP is a TCP packet, wherein the data bytes of the packet comprise:
(a) a serial number of solution for identifying a solution;
(b) authentication information, wherein the NTD checks the NSSP and evaluates its safety according to the authentication information;
(c) operating content, including operation codes and parameters, a sequence of basic operations that NTD needs to perform in the same sequence order that the operation codes appear in the operating content; and
(d) CRC, for checking the integrity of the NSSP.

3. The method for the safety of network terminal devices of claim 1, wherein the NSSIP is a TCP packet, and wherein the data bytes of the packet, comprise:
(a) a number of report, including user marker, timestamp, and serial number; wherein the user marker is used to identify user's information and provides necessary information for the NSC to generate a solution in the future;
wherein the timestamp includes the time information when the NSDs find any suspicious data, and
wherein the serial number is used to distinguish different suspicion reporting sent by NTD;
(b) authentication information, including user authentication information, for checking the legitimacy of the NTDs through related verifying technologies;
(c) suspicion information, including a type portion and a data portion;
wherein the type portion informs whether the content of the suspicion reporting are suspicious network data or anomalies of the NTD; and wherein the data portion is used to fill suspicious network data or anomalies of the NTD according to the type portion; and
(d) a CRC.

4. A method for the safety of network terminal devices of claim 1,
wherein the NSC comprises:
a request receiving module, which receives the NSSIP submitted by the NTD;
an analyzing and processing module, which analyses the NSSIP submitted by the NTD and provides a solution;
an NSSP encoding and encapsulating module, which breaks the solution into a plurality of basic operations with their respective corresponding parameters, obtains a plurality of operation codes by searching the OCT with the plurality of basic operations, and encapsulates the plurality of operation codes and their respective corresponding parameters into a network security solution packet (NSSP);
a transmitting module, which sends the NSSP to the NTD that submitted the NSSIP. wherein the NTD comprises:
a reporting module, which sends the NSSIP to the NSC to process;
a receiving and detecting module, which receives data from the interne, and detects the data using intrusion detection module, wherein the NTD detects system performance using an anomaly detection module; once any suspicious network data or system anomaly is found, fills it into the NSSIP, and submits the NSSIP to the reporting module;
a network security client, which handles the NSSP coming from the NSC, splits the NSSP to get the plurality of operation codes and respective corresponding parameters, retrieves a plurality of call interfaces from the OCT according to the plurality of operation codes, combines the plurality of call interfaces and the respective corresponding parameters to form a local solution, and executes the solution.

5. A method for the safety of network terminal devices of claim 4, wherein the receiving and detecting module comprise:
an intrusion detection module, which detects the data packets;
a data packet receiving module, which receives the data packets from the Internet and sends the data packets to the intrusion detection module;
if the data packets are the hazardous data packets, the intrusion detection module discards the hazardous data packets; if the data packets are safe data packets, the intrusion detection module sends the safe data packets to the processing module, the processing module continues to process the safe data packets normally; if the data packets are the NSSPs, the intrusion detection module sends NSSPs to a network security client; if the data packets are suspicious, the intrusion detection module sends them to a graphical user interface module for a user's intervention, the suspicious data packets are sent to the encoding and encapsulating module, the hazardous data packets are discarded, the safe data packets are sent to the processing module, the processing module continues to process them normally.
an anomaly detection module, which detects the system performance of the NTD to find out and processes the threat of security issues, and sends system anomalies to the encoding and encapsulating module; if the system performance is uncertain, the anomaly detection module sends system performance information to the graphical user interface module for user's intervention, is a system anomaly is confirmed by the user, and the system anomaly will be sent to the encapsulating module.
an NSSIP encapsulating module, which encapsulates the suspicious data packets or anomalies sent from the intrusion detection module or the anomaly detection module into the NSSIP according to packet format, and then sends the NSSIP to the NSC through the Internet.

6. A method for the safety of network terminal devices of claim 5, wherein the network security client comprises:
a control module, which calls each module to accomplish corresponding functions;
a check module, which uses the CRC fields as well as authentication information in the packets to authenticate the integrity and legitimacy of the data;
a splitting module, which, based on the operating content in the NSSP, separates the plurality of operation codes and their respective corresponding parameters from the operating content;
a decoding and extraction module, which, according to the order of operation codes and the mapping of basic operation and operation code in the OCT, forms a plurality of operation interfaces in proper;
an assembly module, which according to the order of the operation codes, combines the plurality of operation interfaces extracted by decoding and extraction module and their respective corresponding parameters separated by splitting module into a local solution;
an executive module, which executes the local solution that combined by assembly module; and
a display and clean-up module, which displays the processing results, and cleans up the garbage generated during network security process.

7. A method for the safety of network terminal devices of claim 4, wherein the request receiving module comprises:
a receiving module, which receives the NSSIP sent by the NTD s from the internet;
a check module, which checks the legitimacy of the NSSIP;
wherein the analyzing and processing module request comprising:
an analyzing module, which analyzes the NSSIP sent by the NTD, and extract the pattern information from the NSSIP;
a query module, which queries the pattern database whether there is a matching according to the pattern information provided by analyzing module, then retrieves the pattern code from the pattern database and sends to extraction module, when there is a matching;
a processing module, which analyzes and processes the pattern information that cannot be identified by the query module, and then generates a solution through artificial means or other equipment;
wherein the NSSP encoding and encapsulating module comprises:
a pattern database, in which the patterns of the known network security issues are stored;
solution database, in which the solutions of the known security issues are stored;
an extraction module, which extracts the corresponding solution from the solution database according to the pattern code, and sends the solution to the test module;
a test module, which breaks the solution into a plurality of basic operations with their respective corresponding parameters and encodes the plurality of basic operations according to the OCT, then tests the plurality of basic operations to ensure that the solution can be executed.
a combination module, which encapsulates the plurality of operation codes and their respective corresponding parameters into the NSSP;
a transmitting module, which sends the NSSP to the NTD that submitted the NSSIP.

8. The method of claim 3, wherein the user marker may include the user's IP address or other unique identity assigned to user by the NSC.

9. The method of claim 3, wherein the timestamp is used to distinguish different suspicion reporting and provides statistic and queuing information for the NSC to handle suspicions sent by the NTDs;

10. The method of claim 3, wherein the suspicion information is a core part of the packet.
